(19) United States
(12) Patent Application Publication
(10) Pub. No.: US 2026/0193853 A1
(43) Pub. Date: Jul. 9, 2026

(54) SYSTEM AND METHOD FOR TRACKING OPERATIONS OF MOBILE MACHINES AT JOBSITES

(71) Applicant: Caterpillar Paving Products Inc., Brooklyn Park, MN (US)

(72) Inventors: Zachary Joseph Vrchota, Brooklyn Park, MN (US); Mark Daniel Behn, St. Michael, MN (US); Todd Alex Impola, Delano, MN (US)

(73) Assignee: Caterpillar Paving Products Inc., Brooklyn Park, MN (US)

(21) Appl. No.: 19/013,000

(22) Filed: Jan. 8, 2025

(51) Int. Cl. E01C 19/00

(52) U.S. Cl. CPC E01C 19/004

(57) ABSTRACT

A system, for tracking an operation of a mobile machine at a jobsite, includes first sensors to obtain first parameters associated with propulsion of the mobile machine along a desired path of the jobsite, second sensors to obtain second parameters associated with steering of the mobile machine along the desired path, and a controller configured to: receive an input to initiate movement of the mobile machine along the desired path to perform the operation; set current location of the mobile machine as a reference location in response to the input; obtain a dimensional data associated with the mobile machine in response to the input; receive, from the first sensors and the second sensors, the first parameters and the second parameters, respectively, based on the input; and determine a location of the mobile machine relative to the reference location based on the first parameters, the second parameters, and the dimensional data.

### TECHNICAL FIELD

The present disclosure relates to mobile machines, such as compactors. More particularly, the present disclosure relates to a system and a method for tracking an operation of a mobile machine traversing along a travel path at a jobsite.

### BACKGROUND

Mobile machines, such as compactors, may be used to modify the characteristics (e.g., density or stiffness) of a work surface at a jobsite. For example, one or more compactors may be driven over the work surface multiple times to achieve a desired compaction target. The desired compaction target may be a set number of compaction passes performed by the compactor(s) or a desired compaction measurement value associated with the work surface.

As the operator maneuvers the compactor along a desired path at the jobsite, they may want to keep track of the number of compaction passes completed in a particular segment or area of the work surface and correlate the compaction measurement values with corresponding locations on the work surface. To gather the location information, these compactors are typically equipped with navigation or positioning systems, such as the Global Positioning System (GPS), or the Global Navigation Satellite System (GNSS), which are expensive and unreliable in regions where satellite signals are weak or unavailable.

US Patent Publication No. 2016/0222602 discloses a guidance system for a compacting machine. The guidance system has a data interface configured to receive real-time information indicative of a paving parameter and to receive project-specific information indicative of a construction parameter. The guidance system further has a locating device configured to determine a location of the compacting machine and processing device in communication with the data interface and the locating device. The processing device is configured to use the real-time information and the project-specific information to determine a rolling pattern for the compacting machine and, based on the location of the compacting machine and the rolling pattern, provide directional guidance to the compacting machine.

### SUMMARY OF THE INVENTION

In one aspect, the disclosure relates to a system for tracking an operation of a mobile machine at a jobsite. The system includes one or more first sensors, one or more second sensors, and a controller. The one or more first sensors are configured to obtain one or more first parameters associated with a propulsion of the mobile machine along a desired path of the jobsite. The one or more second sensors are configured to obtain one or more second parameters associated with a steering of the mobile machine along the desired path. The controller is configured to receive an input to initiate movement of the mobile machine along the desired path to perform the operation. Further, the controller is configured to set a current location of the mobile machine as a reference location in response to the input. Furthermore, the controller is configured to obtain a dimensional data associated with the mobile machine in response to the input. Moreover, the controller is configured to receive, from the one or more first sensors and the one or more second sensors, the one or more first parameters and the one or more second parameters, respectively, based on the input. In addition, the controller is configured to determine a location of the mobile machine relative to the reference location based on the one or more first parameters, the one or more second parameters, and the dimensional data.

In another aspect, the disclosure is directed to a method for tracking an operation of a mobile machine at a jobsite. The method includes receiving, by a controller, an input to initiate movement of the mobile machine along a desired path of the jobsite to perform the operation. Further, the method includes setting, by the controller, a current location of the mobile machine as a reference location in response to the input. Furthermore, the method includes obtaining, by the controller, a dimensional data associated with the mobile machine in response to the input. Also, the method includes receiving, by the controller, one or more first parameters associated with a propulsion of the mobile machine along the desired path from one or more first sensors. Moreover, the method includes receiving, by the controller, one or more second parameters associated with a steering of the mobile machine along the desired path from one or more second sensors. In addition, the method includes determining, by the controller, a location of the mobile machine relative to the reference location based on the one or more first parameters, the one or more second parameters, and the dimensional data.

In yet another aspect, the disclosure relates to a compactor. The compactor includes a compacting drum configured to perform a compaction operation on a work surface as the compactor moves along a desired path at a jobsite, a propulsion system for powering movement of the compactor along the desired path, a steering system for steering the compactor along the desired path, and a system for tracking the compaction operation of the compactor at the jobsite. The system includes one or more first sensors, one or more second sensors, and a controller. The one or more first sensors are configured to obtain one or more first parameters associated with a propulsion of the mobile machine along a desired path of the jobsite. The one or more second sensors are configured to obtain one or more second parameters associated with a steering of the mobile machine along the desired path. The controller is configured to receive an input to initiate movement of the mobile machine along the desired path to perform the operation. Further, the controller is configured to set a current location of the mobile machine as a reference location in response to the input. Furthermore, the controller is configured to obtain a dimensional data associated with the mobile machine in response to the input. Moreover, the controller is configured to receive, from the one or more first sensors and the one or more second sensors, the one or more first parameters and the one or more second parameters, respectively, based on the input. In addition, the controller is configured to determine a location of the mobile machine relative to the reference location based on the one or more first parameters, the one or more second parameters, and the dimensional data.

### BRIEF DESCRIPTION OF THE DRAWINGS

FIG. 1 is a side view of a mobile machine traversing a work surface of a jobsite;

FIG. 2 illustrates a system for tracking an operation of the mobile machine at the jobsite;

FIG. 3 is a flowchart illustrating a method for tracking the operation of the mobile machine at the jobsite; and

FIGS. 4 and 5 illustrate a control interface of the mobile machine displaying a compaction value profile associated with the work surface.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

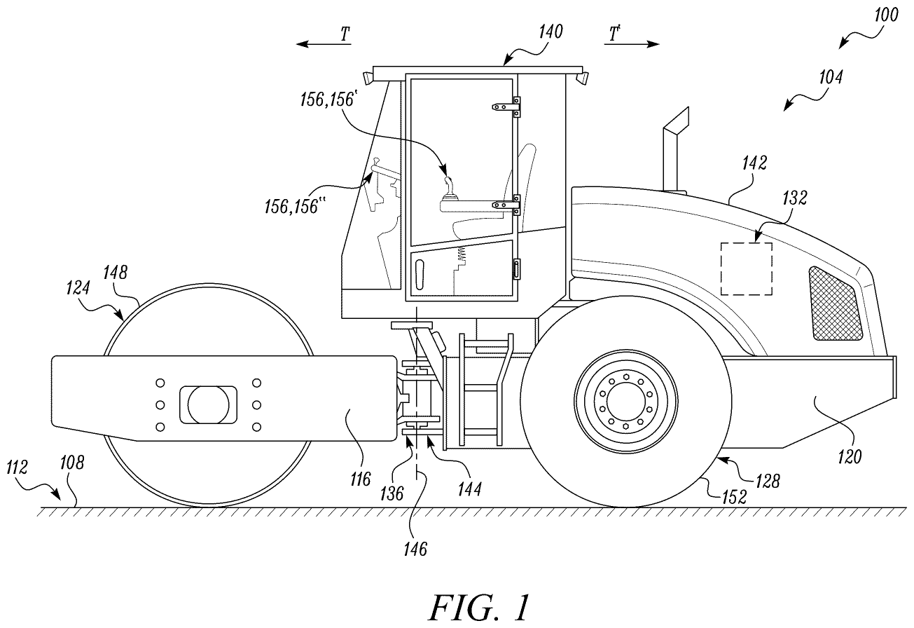

Referring to FIG. 1, a mobile machine 100, as a compactor 104, is disclosed. The compactor 104 may be configured for use in, for example, road construction, highway construction, parking lot construction, and other paving, soil compaction and/or construction applications. For example, the compactor 104 may be used in situations where it is necessary to compress loose stone, gravel, soil, sand, concrete, and/or other materials of a work surface 108 (at a jobsite 112) to a state of greater compaction and/or density. Similarly, the compactor 104 may compress freshly deposited asphalt or other materials disposed on and/or associated with the work surface 108. As the compactor 104 traverses the work surface 108 (along a desired path), vibrational forces generated by the compactor 104 and imparted to the work surface 108, acting in cooperation with the weight of the compactor 104, compresses the loose materials. The compactor 104 typically makes one or more passes over the work surface 108 to provide a desired level of compaction.

Although described subsequently in reference to the compactor 104, the methods, systems, techniques of the present disclosure are equally applicable to other mobile machines such earth moving equipment, mining equipment and other paving equipment that operate in a defined jobsite where a defined jobsite periphery is desired.

The compactor 104 includes a first frame 116, a second frame 120, a first traction unit 124, a second traction unit 128, a propulsion system 132, a steering system 136, and an operator cabin 140. The first frame 116 may be a non-engine frame portion of the compactor 104, and the second frame 120 may be an engine frame portion of the compactor 104 (e.g., supporting a compartment 142 that may house the propulsion system 132). The first frame 116 and the second frame 120 may be operatively coupled to one another, for example, via an articulated joint 144. The articulated joint 144 may be configured to enable a rotational movement between the first frame 116 and the second frame 120 about an axis 146 that may extend perpendicular to forward and rearward traveling directions, T and T′, of the compactor 104. While an articulated joint 144 between the first frame 116 and the second frame 120 is shown in FIG. 1, it should be noted that the aspects of the present disclosure may be applied to machines that include a non-articulated frame assembly.

The first traction unit 124 may be operatively coupled to the first frame 116 and configured to compact the work surface 108 via rolling engagement with the work surface 108. The first traction unit 124 may include a compacting drum 148. The compacting drum 148 may be operatively coupled to the propulsion system 132 to receive mechanical power from the propulsion system 132 to propel over the work surface 108. The compacting drum 148 may include a vibratory compaction mechanism. A circumferential surface of the compacting drum 148 may be a smooth surface, a textured surface, such as that on a tipped drum, or any other compacting drum surface structure known in the art.

The second traction unit 128 may be operatively coupled to the second frame 120 and configured to propel the second frame 120 over the work surface 108 via rolling engagement with the work surface 108. The second traction unit 128 may include a pair of wheels (only one wheel 152 of the pair of wheels is shown in FIG. 1). The wheels 152 are operatively coupled to the propulsion system 132 for transfer of mechanical power from the propulsion system 132 to the wheels 152 to propel the compactor 104 over the work surface 108. Although the second traction unit 128 as the wheels 152 is discussed and shown in FIG. 1, it may be noted that, in other embodiments, the second traction unit 128 may include at least one of a compacting drum, a track drive, a belt drive, or any other land-based propulsion device known in the art.

The propulsion system 132 is configured to power operations, e.g., movement of the compactor 104 along the desired path at the jobsite 112. The propulsion system 132 may include a power source (not shown) for generating mechanical power, and hydraulic circuits (not shown) for transmitting mechanical power from the power source to the first traction unit 124 (i.e., the compacting drum 148) and the second traction unit 128 (i.e., wheels 152). The power source may include a combustion engine, a gas turbine, or any other prime mover known in the art. In some embodiments, the power source may be an electric power source and may include battery systems, fuel cells, and the like.

In an example, the hydraulic circuits may be hydrostatic drive circuits including one or more hydraulic pumps (e.g., bi-directional flow pumps) operatively coupled with the power source for transmission of mechanical power therebetween, and one or more hydraulic motors (e.g., bi-directional hydraulic motors) fluidly coupled with the corresponding one or more hydraulic pumps and operatively coupled with the corresponding first traction unit 124 and the second traction unit 128 (e.g., via corresponding shafts, not shown). In a first operating configuration of the hydraulic circuits (i.e., when the hydraulic fluid flows within each hydraulic circuit in a first direction), the propulsion system 132 facilitates rotation of the first traction unit 124 and the second traction unit 128 in a first direction, for example, to propel the compactor 104 along the forward traveling direction, T. In second operating configuration of the hydraulic circuits, (i.e., when the hydraulic fluid flows within each hydraulic circuit in a second direction opposite to the first direction), the propulsion system 132 facilitates rotation of the first traction unit 124 and the second traction unit 128 in a second direction opposite to the first direction, for example, to propel the compactor 104 along the rearward traveling direction, T′.

The steering system 136 may be an articulation steering system configured to steer the compactor 104 along the desired path (at the jobsite 112) during operation. In an embodiment, the steering system 136 may include one or more hydraulic actuators operatively coupled with the articulated joint 144. During operation, the position, actuation speed, actuation direction, etc., of the hydraulic actuators may be adjusted (e.g., based on control signals, for example, received from an input device 156 located in the operator cabin 140) to control the steering of the compactor 104 along the desired path at the jobsite 112. Further, it should be noted that in non-articulated configurations of the compactor 104 (or the mobile machine 100), for instance, a different type of steering system than the steering system 136 may be used to steer the mobile machine 100.

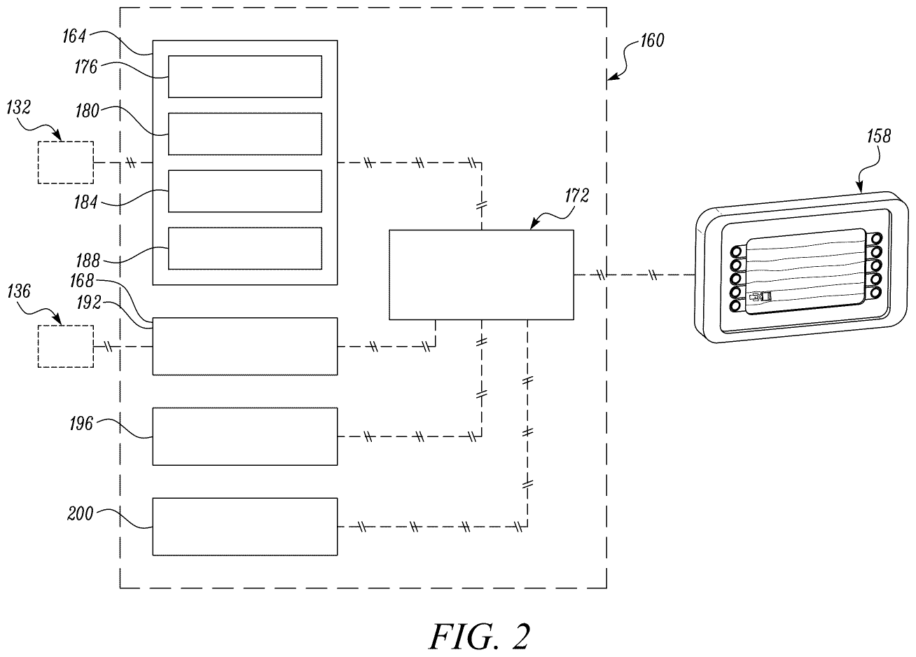

The operator cabin 140 may facilitate stationing of one or more operators therein, to monitor the operations of the mobile machine 100 (e.g., the compactor 104). In an embodiment, as shown in FIG. 1, the operator cabin 140 may be supported on the second frame 120 of the compactor 104. Alternatively, the operator cabin 140 may be supported on the first frame 116 of the compactor 104 or the mobile machine 100. Also, the operator cabin 140 may house various components and controls of the compactor 104, access to one or more of which may help the operators to control the machine's movement (e.g., propulsion and steering) and/or operation. For example, the operator cabin 140 may include the input devices 156 (e.g., joystick 156′, steering wheel 156″, etc.) that may be used and/or actuated to generate an input for controlling movement of the compactor 104, and a control interface 158 (shown in FIG. 2) that may be used to receive requests for controlling movement of the compactor 104 or to display information associated with the operation of the compactor 104.

In an operation, the mobile machine 100 may be maneuvered over the work surface 108 (at the jobsite 112) one or more times until a desired work surface profile is achieved. For example, during a compaction operation, the compactor 104 may be maneuvered over the work surface 108 multiple times until the work surface 108 is compacted to a target compaction level. Material being compacted is normally initially soft and of low density before compaction begins. After each pass of the compactor 104, the level of compaction of the material incrementally increases and therefore, the subsequent passes should be performed to achieve the target compaction level. During the compaction operation, the operator (associated with the compactor 104) may want to monitor the current level of compaction, for example, of a particular segment or area of the work surface 108. For that, the operator may want to track the operation (i.e., number of compaction passes) of the compactor 104 traversing through the segment or area on the work surface 108.

To track the operation of the compactor 104 at the jobsite 112, a system 160 is disclosed. The system 160 facilitates determination of the location of the compactor 104 without navigation or positioning systems, such as the Global Positioning System (GPS), or the Global Navigation Satellite System (GNSS), or in regions where satellite signals are weak or unavailable. For that, the system 160 includes one or more first sensors 164, one or more second sensors 168, and a controller 172. Each of the first sensors 164, the second sensors 168, and the controller 172 is now discussed in detail with reference to FIG. 2.

The first sensors 164 are configured to obtain first parameters associated with the propulsion of the mobile machine 100 (e.g., the compactor 104). The first parameters may include at least one of a hydraulic pressure differential value and a hydraulic flow rate value associated with the propulsion system 132 of the mobile machine 100. In example, the first sensors 164 may include a first pressure sensor 176 and a second pressure sensor 180. The first pressure sensor 176 may be fluidly coupled with corresponding hydrostatic circuit driving the first traction unit 124 (i.e., the compacting drum 148) of the compactor 104. The first pressure sensor 176 may be a differential pressure sensor configured to generate signals indicative of a hydraulic pressure differential driving the hydraulic motor of the hydrostatic circuit associated with the first traction unit 124. Similarly, the second pressure sensor 180 may be fluidly coupled with the corresponding hydrostatic circuit driving the second traction unit 128, for example, the wheels 152 of the compactor 104. The second pressure sensor 180 may be a differential pressure sensor configured to generate signals indicative of a hydraulic pressure differential driving the hydraulic motor of the hydrostatic circuit associated with the second traction unit 128. The first pressure sensor 176 and the second pressure sensor 180 may be communicably coupled with the controller 172 for transmitting the corresponding signals (indicative of the pressure differential values, as the first parameters) to the controller 172.

In another example, the first pressure sensors 176 may include a first flow rate sensor 184 and a second flow rate sensor 188. The first flow rate sensor 184 may be a mass flow rate sensor configured to generate signals indicative of a hydraulic flow rate of the fluid circulating through the hydrostatic circuit associated with the first traction unit 124. Similarly, the second flow rate sensor 188 may be a mass flow rate sensor configured to generate signals indicative of a hydraulic flow rate of the fluid circulating through the hydrostatic circuit associated with the second traction unit 128. Both the first flow rate sensor 184 and the second flow rate sensor 188 may be communicably coupled with the controller 172 for transmitting the corresponding signals (indicative of the hydraulic flow rate values, as the first parameters) to the controller 172.

In an alternative embodiment, the first sensors 164 may include speed sensors associated with at least one of the first traction unit 124 and the second traction unit 128. The speed sensors may be configured to generate signals indicative of a rotational speed (to be used as the first parameters) of at least one of the first traction unit 124 and the second traction unit 128. Examples of such speed sensors may include, but not limited to, a tachometer, a Hall effect sensor, an optical sensor, a magnetic sensor, a proximity sensor and an inductive sensor.

The one or more second sensors 168 are configured to obtain one or more second parameters associated with the steering of the mobile machine 100 (e.g., the compactor 104). The second parameters may include a steering angle of the mobile machine 100. It should be noted that “steering angle” may refer to an angle of at least one of the first traction unit 124 and the second traction unit 128 relative to a longitudinal axis (e.g., along a travelling direction) of the mobile machine 100. For example, the steering angle may refer to an angle of the compacting drum 148 (or the wheels 152) relative to the longitudinal axis of the compactor 104. In an embodiment, the second sensors 168 include a steering angle sensor 192 configured to detect movements of the steering system 136 that are indicative of the steering angle of the mobile machine 100 (e.g., the compactor 104). Movements of the steering system 136 that are indicative of the steering angle of the mobile machine 100 may include displacements of the hydraulic actuator (of the steering system 136), movements of linkage members of the steering system 136, rotation of the articulated joint 144, or the like. Further, the second sensors 168 may be communicably coupled with the controller 172 for transmitting the corresponding signals (indicative of the second parameters) to the controller 172.

The controller 172 may include a computing device having a single microprocessor or multiple microprocessors. For example, the controller 172 may include a memory, a secondary storage device, a clock, and a processing hardware, one or more of which may be used, in concert with another part of the controller 172, for accomplishing a task as discussed below in the present disclosure. The controller 172 may be configured to receive inputs (e.g., signals) from one or more components of the compactor 100, such as the first sensors 164 and the second sensors 168, process the inputs, and generate output signals based on the inputs and/or the processed data.

The controller 172 is communicably coupled with the first sensors 164, the second sensors 168. In addition, the controller 172 is communicably coupled with the input device 156 and an output device. By way of the controller's 172 communicable coupling with the input device 156, the controller 172 is configured to receive inputs associated with the movement of the mobile machine 100 along the desired path to perform the operation. For example, the controller 172 is configured to receive an input (e.g., from the input device 156) to initiate the movement of the compactor 104 along the desired path to perform the compaction operation on the work surface 108.

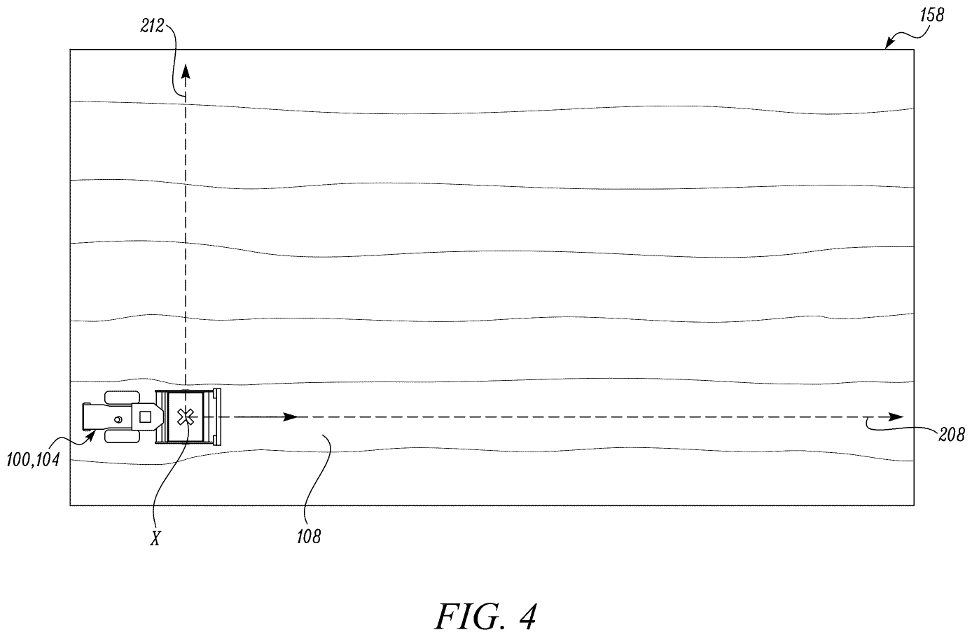

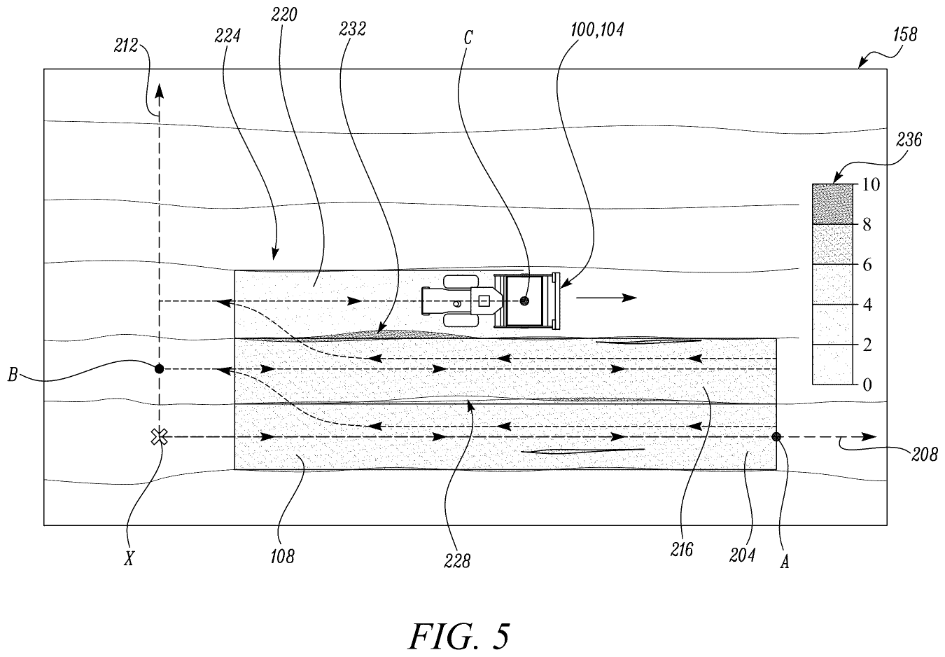

In response to the receipt of the input (e.g., from the input device 156) to initiate the movement of the mobile machine 100 along the desired path, the controller 172 is configured to set a current location of the mobile machine 100 as a reference location at the jobsite 112. In an example, the controller 172 may set a point of contact of the compacting drum 148 and a region of the work surface 108 lying beneath the compacting drum 148 as a reference location (shown as ‘X’ in FIGS. 4 and 5). In another example, the controller 172 may set a location of a forwardmost portion of the compactor 104 as a reference location. In yet another example, the controller 172 may set a location of the articulated joint 144 as a reference location.

In addition, the controller 172 is further configured to obtain a dimensional data associated with the mobile machine 100 in response to the receipt of the input to initiate the movement of the mobile machine 100. For example, the controller 172 may obtain at least one of a diameter of the first traction unit 124 (e.g., the compacting drum 148), a width of the compacting drum 148, a length of the compactor 104, a width of the compactor 104, or the like. In an example, the dimensional data may be pre-stored in a memory 196 of the controller 172. In another example, the controller 172 may obtain the dimensional data from a dedicated machine controller (e.g., ECM) associated with the compactor 104.

By way of the controller's 172 communicable coupling with the first sensors 164, the controller 172 is configured to receive the signals indicative of the first parameters from the first sensors 164. The controller 172 receives the signals indicative of the first parameters from the first sensors 164 based on the input, for example, to initiate the movement of the compactor 104. In an example, the controller 172 may receive the signals indicative of the pressure differential values corresponding to the hydrostatic circuit (of the propulsion system 132) driving the first traction unit 124 from the first pressure sensor 176, and may receive the signals indicative of the pressure differential values corresponding to the hydrostatic circuit (of the propulsion system 132) driving the second traction unit 128 from the second pressure sensor 180.

In another example, the controller 172 may receive the signals indicative of the hydraulic flow rate values corresponding to the hydrostatic circuit (of the propulsion system 132) driving the first traction unit 124 from the first flow rate sensor 184, and may receive the signals indicative of the hydraulic flow rate values corresponding to the hydrostatic circuit (of the propulsion system 132) driving the second traction unit 128 from the second flow rate sensor 188. The controller 172 may utilize the hydraulic flow rate values (received from the first flow rate sensor 184 and the second flow rate sensor 188) to determine the machine travel speed and the machine travel direction.

Further, by way of the controller's 172 communicable coupling with the second sensor 168, the controller 172 is configured to receive the signals indicative of the second parameters from the second sensor 168. In an example, the controller 172 receives, from the steering angle sensor 192, the signals related to the steering angle of the compactor 104, as the compactor 104 traverse along the desired path. For example, the steering angle sensor 192 may generate and provide (e.g., continuously, periodically, aperiodically, or the like) information (e.g., displacements of the hydraulic actuator of the steering system 136, or rotation of the articulated joint 144, etc.) to the controller 172 that is indicative of the steering angle of the compactor 104. Accordingly, the controller 172 may determine the steering angle of the compactor 104 based on the information.

Based on the first parameters, the second parameters, and the dimensional data, the controller 172 is configured to determine a location of the compactor 104 relative to the reference location (shown as ‘X’ in FIG. 4). In an example, the controller 172 may utilize the pressure differential values, received from the first pressure sensor 176 and the second pressure sensor 180), to determine a machine travel speed (e.g., ground speed of the compactor 104) and a machine travel direction (e.g., forward or rearward travelling directions T-T′). In another example, the controller 172 may utilize the hydraulic flow rate values (received from the first flow rate sensor 184 and the second flow rate sensor 188) to determine the machine travel speed and the machine travel direction. Further, the controller 172 may utilize the machine travel speed, the machine travel direction, the steering angle value, and at least one of the diameter and the width of the compacting drum 148, to determine the distance travelled by the compactor 104 from the reference location ‘X’, and hence, the current location of the compactor 104 relative to the reference location ‘X’.

Additionally, the controller 172 may be configured to determine a compaction level of the work surface 108, as the compactor 104 is maneuvered over the work surface 108 along the desired path at the jobsite 112. For that, the controller 172 may receive, from one or more third sensors 200 associated with the compactor 104, signals indicative of one or more characteristics of the work surface 108 related to a compaction value of the work surface 108. Examples of the characteristics of the work surface 108 may include, but not limited to, stiffness, density, modulus, or any other suitable parameter representative of a compaction state of the work surface 108.

In an example, the third sensors 200 may be the same as the first sensors 164, i.e., the first pressure sensor 176, the second pressure sensor 180, the first flow rate sensor 184, and the second flow rate sensor 188. Accordingly, the controller 172 may utilize the hydraulic pressure differential values and the hydraulic flow rate values (received from the third sensors 200) to determine the machine drive power (MDP) values required to propel the compactor 104 on the work surface 108, and hence, the compaction values of the work surface 108 based on the corresponding machine drive power values (e.g., by utilizing a map correlating the machine drive power values with prestored compaction values).

In another example, the third sensors 200 may be different from the first sensors 164, and may include, but not limited to, non-contact and/or contact sensors, for example, sonic sensors, infrared sensors, radar sensors, moisture sensors, temperature sensors, accelerometers, gage wheels, or any other suitable monitoring devices known in the art.

Further, the controller 172 may be configured to generate a compaction value profile (e.g., compaction map) based on the compaction values of the work surface 108 over which the compactor 104 is driven and the location of the compactor 104 relative to the reference location ‘X’. In addition, the controller 172 may be configured to display the compaction value profile through the control interface 158 associated with the compactor 104. In an example, the controller 172 may combine each compaction value with a corresponding location (e.g., location relative to the reference location ‘X’) to create a map of an area compacted by the compactor 104. The map may be color coded to indicate which areas are sufficiently compacted (e.g., green) and those that may need additional compaction (e.g., red), as shown in FIGS. 4 and 5.

### INDUSTRIAL APPLICABILITY

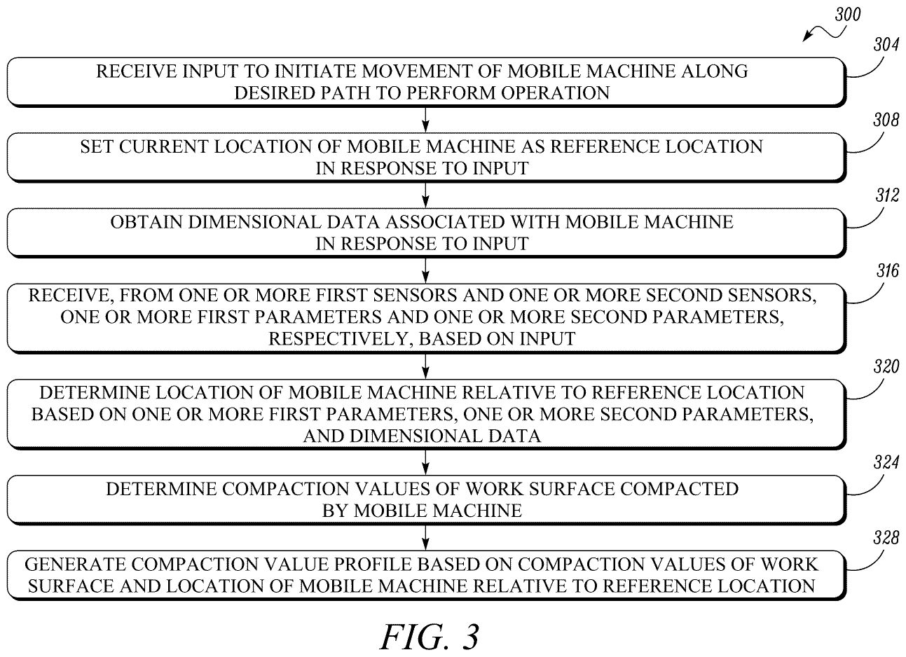

Referring to FIG. 3, an example method for tracking an operation of the mobile machine 100 (e.g., compactor 104) at the jobsite 112, using the system 160, is discussed. The method discussed by way of a flowchart 300 that illustrates exemplary stages (e.g., from 602 to 604) associated with the method. The method is also discussed in conjunction with FIGS. 1, 2, 4, and 5. It will be appreciated that the order of steps described in the method is exemplary in nature and that the steps can be performed in a different order than what is set out below, as will be contemplated by a person skilled in the art based on the description of the present disclosure.

During an exemplary operation, when the compactor 104 rests stationary on the work surface 108, an operator(s) of the compactor 104 may desire to drive the compactor 104 over the work surface 108 along a desired path at the jobsite 112. To this end, the operator may actuate the input device 156, for example, to request for a movement of the compactor 104 along the desired path. Upon actuating the input device 156, an input to initiate the movement of the compactor 104 over the work surface 108 is generated and received by the controller 172, at step 304. In another example, the input may correspond to initiating a compacting mechanism associated with the compacting drum 148 of the compactor 104.

In response to the receipt of the input (e.g., from the input device 156) to initiate the movement of the compactor 104 along the desired path, the controller 172 sets a current location of the compactor 104 as the reference location ‘X’ at the jobsite 112 (as shown in FIG. 4), at step 308. In an example, the controller 172 may set a point of contact of the compacting drum 148 and a region of the work surface 108 lying beneath the compacting drum 148 as a reference location (shown as ‘X’ in FIGS. 4 and 5). Additionally, the controller 172 obtains the dimensional data associated with the compactor 104 in response to the input, at step 312. Examples of the dimensional data may include, but not limited to, a diameter of the first traction unit 124 (e.g., the compacting drum 148), a width of the compacting drum 148, a length of the compactor 104, a width of the compactor 104, or the like.

Further, based on the input to initiate movement of the compactor 104 to perform the operation, the controller 172 receives the first parameters associated with the propulsion of the compactor 104 and the second parameters associated with the steering of the compactor 104, as the compactor 104 moves over the work surface 108 along the desired path (at the jobsite 112), at step 316. In an example, the controller 172 may receive signals indicative of hydraulic pressure differential corresponding to the hydrostatic circuit (of the propulsion system 132) driving the first traction unit 124 from the first pressure sensor 176, and may receive the signals indicative of the hydraulic pressure differential corresponding to the hydrostatic circuit (of the propulsion system 132) driving the second traction unit 128 from the second pressure sensor 180, as the compactor 104 moves over the work surface 108 along the desired path (at the jobsite 112) to perform the operation. Simultaneously, the controller 172 may receive signals (from the second sensors 168) indicative of the steering angle of the compactor 104, as the compactor 104 traverses over the work surface 108 along the desired path.

Based on the first parameters, the second parameters, and the dimensional data, the controller 172 determines a location (i.e., current location) of the compactor 104 relative to the reference location (shown as ‘X’ in FIG. 4), at step 320. In an example, the controller 172 may utilize the pressure differential values (i.e., first parameter), received from the first pressure sensor 176 and the second pressure sensor 180), to determine a machine travel speed (e.g., ground speed of the compactor 104) and a machine travel direction (e.g., forward or rearward travelling directions T-T′). The controller 172 may further utilize the calculated machine travel speed and the machine travel direction along with the steering angle value (i.e., second parameter) and the diameter and/or the width of the compacting drum 148 (i.e., dimensional data), to determine the current location of the compactor 104 relative to the reference location ‘X’.

That is, the controller 172 may determine the current location of the compactor 104 as a function of the machine travel speed, the machine travel direction, the steering angle, and the dimensional data of the compactor 104. In an example, as shown in FIG. 5, based on a zero-steering angle, the calculated machine travel speed and the travel direction (e.g., forward), the controller 172 may determine that the compactor 104 is at a location ‘A’ (along a first desired path 204) having a longitudinal coordinate equal to fifteen times the diameter of the compacting drum 148 and a lateral coordinate equal to zero (as the steering angle is zero). It should be noted that the term “longitudinal coordinate” refers to a longitudinal distance between the compactor 104 (e.g., point of contact of the compacting drum 148 and the work surface 108) and the reference location ‘X’ (e.g., shown along an abscissa 208), whereas the term “lateral coordinate” refers to a transverse distance (e.g., orthogonal to the longitudinal distance) between the compactor 104 and the reference location ‘X’ (e.g., shown along an ordinate 212).

As the compactor 104 is further maneuvered (steered) from the first desired path 204 towards a second desired path 216, the controller 172 may receive signals (from the second sensor 168) indicative of a non-zero steering angle. The controller 172 may use the non-zero steering angle along with the information related to the machine trave speed and the machine travel direction to determine the current location of the compactor 104 relative to the reference location ‘X’. For example, the controller 172 may determine that the compactor 104 is at a location ‘B’ having a longitudinal coordinate equal to zero and a lateral coordinate equal to the width of the compactor 104 (or the compacting drum 148), based on the change on the steering angle values, the machine travel speed and direction. Further, as the compactor 104 is maneuvered (steered) from the second desired path 216 towards a third desired path 220, the controller 172 may determine that the compactor 104 is at a location ‘C’ (along the third desired path 220) having a longitudinal coordinate equal to seven times the diameter of the compacting drum 148 and a lateral coordinate equal to twice the width of the compactor 104 (or the compacting drum 148), based on a further change in the steering angle values, the machine travel speed, and the machine travel direction.

Additionally, as the compactor 104 is maneuvered over the work surface 108, the controller 172 may determine the compaction values of the work surface 108, at step 324. For that, the controller 172 may receive signals (from the third sensors 200) indicative of the characteristics (e.g., stiffness, density, etc.) of the work surface 108 related to the compaction value of the work surface 108. The controller may further correlate the compaction values of the work surface 108 with the corresponding locations of the compactor 104 (relative to the reference location ‘X’) to generate a compaction value profile 224 (shown in FIG. 5) associated with the work surface 108, at step 328.

Further, the controller 172 may display the compaction value profile 224 of the work surface 108 through the control interface 158. The compaction value profile 224 may be displayed as a two-dimensional profile of the work surface 108 showing the different compaction values corresponding to different locations of the work surface 108. Various locations of the work surface 108 may be color-coded, cross-hatched, or gray-scaled to correspondingly indicate the compaction values of the work surface 108. For example, a first compaction value associated with a first location 228 (relative to the reference location ‘X’) of the work surface 108 may be indicated via a first color and a second compaction value associated with a second location 232 (relative to the reference location ‘X’) of the work surface 108 may be indicated via a second color. The association between the color and the compaction value may be represented by a scale 236. Further, as the compactor 104 is maneuvered over different locations of the work surface 108 to perform the compaction operation, the controller 172 may correspondingly update the compaction values of the work surface 108. For example, as the compaction value of the first location 228 is modified, the color of the work surface 108 at the first location 228 as represented on the control interface 158 may change to indicate the modified compaction value.

The system 160 provides a cost-efficient solution for determining the location of the mobile machine 100 (e.g., compactor 104) maneuvering over the work surface 108, without using dedicated navigation or positioning systems, such as the Global Positioning System (GPS), or the Global Navigation Satellite System (GNSS). For that, the system 160 utilizes the existing sensors, such as the pressure differential sensors, hydraulic flow rate sensors, and steering angle sensors, to determine the location of the mobile machine 100 relative to a set reference point (e.g., reference location ‘X’) on the work surface 108. In addition, the system 160 provides information associated with the compaction values corresponding to different locations of the work surface 108 relative to the set reference point.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the system, the method and/or the compactor of the present disclosure without departing from the scope of the disclosure. Other embodiments will be apparent to those skilled in the art from consideration of the specification and practice of the enclosure, the system, the method and/or the compactor disclosed herein. It is intended that the specification and examples be considered as exemplary only, with a true scope of the disclosure being indicated by the following claims and their equivalent.

What is claimed is:

1. A system for tracking an operation of a mobile machine at a jobsite, the system comprising:
one or more first sensors configured to obtain one or more first parameters associated with a propulsion of the mobile machine along a desired path of the jobsite;
one or more second sensors configured to obtain one or more second parameters associated with a steering of the mobile machine along the desired path; and
a controller configured to:
receive an input to initiate movement of the mobile machine along the desired path to perform the operation;
set a current location of the mobile machine as a reference location in response to the input;
obtain a dimensional data associated with the mobile machine in response to the input;
receive, from the one or more first sensors and the one or more second sensors, the one or more first parameters and the one or more second parameters, respectively, based on the input; and
determine a location of the mobile machine relative to the reference location based on the one or more first parameters, the one or more second parameters, and the dimensional data.

2. The system of claim 1, wherein the one or more first parameters include at least one of a hydraulic pressure differential value and a hydraulic flow rate value associated with a propulsion system for propelling the mobile machine.

3. The system of claim 2, wherein the one or more second parameters includes a steering angle of the mobile machine.

4. The system of claim 3, wherein the mobile machine includes a compacting drum configured to compact a work surface via rolling engagement with the work surface as the mobile machine moves along the desired path, and wherein the dimensional data associated with the mobile machine includes at least one of a diameter of the compacting drum and a width of the compacting drum.

5. The system of claim 4, wherein, to determine the location of the mobile machine relative to the reference location, the controller is configured to:
calculate a machine travel speed and a machine travel direction based on at least one of the hydraulic pressure differential value and the hydraulic flow rate value associated with the propulsion system; and
determine the location of the mobile machine relative to the reference location based on the machine travel speed, the machine travel direction, the steering angle, and the at least one of the diameter and the width of the compacting drum.

6. The system of claim 1, wherein the mobile machine includes a compacting drum configured to compact a work surface via rolling engagement with the work surface as the mobile machine moves along the desired path, and wherein the controller is configured to:
receive, from one or more third sensors associated with the mobile machine, signals indicative of one or more characteristics of the work surface related to a compaction value of the work surface;
determine compaction values of the work surface based on the signals from the one or more third sensors; and
generate a compaction value profile based on the compaction values of the work surface and the location of the mobile machine relative to the reference location.

7. The system of claim 6, wherein the controller is configured to display the compaction value profile through a control interface associated with the mobile machine.

8. A method for tracking an operation of a mobile machine at a jobsite, the method comprising:
receiving, by a controller, an input to initiate movement of the mobile machine along a desired path of the jobsite to perform the operation;
setting, by the controller, a current location of the mobile machine as a reference location in response to the input;
obtaining, by the controller, a dimensional data associated with the mobile machine in response to the input;
receiving, by the controller, one or more first parameters associated with a propulsion of the mobile machine along the desired path from one or more first sensors;
receiving, by the controller, one or more second parameters associated with a steering of the mobile machine along the desired path from one or more second sensors; and
determining, by the controller, a location of the mobile machine relative to the reference location based on the one or more first parameters, the one or more second parameters, and the dimensional data.

9. The method of claim 8, wherein the one or more first parameters include at least one of a hydraulic pressure differential value and a hydraulic flow rate value associated with a propulsion system for propelling the mobile machine.

10. The method of claim 9, wherein the one or more second parameters includes a steering angle of the mobile machine.

11. The method of claim 10, wherein the mobile machine includes a compacting drum configured to compact a work surface via rolling engagement with the work surface as the mobile machine moves along the desired path, and wherein the dimensional data associated with the mobile machine includes at least one of a diameter of the compacting drum and a width of the compacting drum.

12. The method of claim 11, wherein determining the location of the mobile machine relative to the reference location includes:
calculating a machine travel speed and a machine travel direction based on at least one of the hydraulic pressure differential value and the hydraulic flow rate value associated with the propulsion system; and
determining the location of the mobile machine relative to the reference location based on the machine travel speed, the machine travel direction, the steering angle, and the at least one of the diameter and the width of the compacting drum.

13. The method of claim 8, wherein the mobile machine includes a compacting drum configured to compact a work surface via rolling engagement with the work surface as the mobile machine moves along the desired path, and wherein the method includes:
receiving, by the controller, signals indicative of one or more characteristics of the work surface related to a compaction value of the work surface from one or more third sensors associated with the mobile machine;
determining, by the controller, compaction values of the work surface based on the signals from the one or more third sensors; and
generating, by the controller, a compaction value profile based on the compaction values of the work surface and the location of the mobile machine relative to the reference location.

14. The method of claim 13 further including displaying, by the controller, the compaction value profile through a control interface associated with the mobile machine.

15. A compactor, comprising:
a compacting drum configured to perform a compaction operation on a work surface as the compactor moves along a desired path at a jobsite;
a propulsion system for powering movement of the compactor along the desired path;
a steering system for steering the compactor along the desired path; and
a system for tracking the compaction operation of the compactor at the jobsite, the system including:
one or more first sensors configured to obtain one or more first parameters associated with a propulsion of the compactor along the desired path;
one or more second sensors configured to obtain one or more second parameters associated with the steering of the compactor along the desired path; and
a controller configured to:
receive an input to initiate the movement of the compactor along the desired path to perform the compaction operation;
set a current location of the compactor as a reference location in response to the input;
obtain a dimensional data associated with the compactor in response to the input;
receive, from the one or more first sensors and the one or more second sensors, the one or more first parameters and the one or more second parameters, respectively, based on the input; and
determine a location of the compactor relative to the reference location based on the one or more first parameters, the one or more second parameters, and the dimensional data.

16. The compactor of claim 15, wherein the one or more first parameters include at least one of a hydraulic pressure differential value and a hydraulic flow rate value associated with the propulsion system.

17. The compactor of claim 16, wherein the one or more second parameters includes a steering angle of the compactor.

18. The compactor of claim 17, wherein the dimensional data associated with the compactor includes at least one of a diameter of the compacting drum and a width of the compacting drum.

19. The compactor of claim 18, wherein, to determine the location of the compactor relative to the reference location, the controller is configured to:
calculate a machine travel speed and a machine travel direction based on at least one of the hydraulic pressure differential value and the hydraulic flow rate value associated with the propulsion system; and
determine the location of the compactor relative to the reference location based on the machine travel speed, the machine travel direction, the steering angle, and the at least one of the diameter and the width of the compacting drum.

20. The compactor of claim 15, wherein the controller is configured to:
receive, from one or more third sensors associated with the compactor, signals indicative of one or more characteristics of the work surface related to a compaction value of the work surface;
determine compaction values of the work surface based on the signals from the one or more third sensors;
generate a compaction value profile based on the compaction values of the work surface and the location of the compactor relative to the reference location; and
display the compaction value profile through a control interface associated with the compactor.
